(19) United States
(12) Patent Application Publication
(10) Pub. No.: US 2012/0190305 A1
(43) Pub. Date: Jul. 26, 2012

(54) BATTERY LEVEL INDICATION BY PORTABLE TELEPHONE

(75) Inventor: Luc Wuidart, Pourrieres (FR)

(73) Assignee: STMICROELECTRONICS (ROUSSET) SAS, Rousset (FR)

(21) Appl. No.: 13/349,457

(22) Filed: Jan. 12, 2012

(30) Foreign Application Priority Data
Jan. 21, 2011 (FR) 11 50489

(51) Int. Cl. H04B 7/00

(52) U.S. Cl. 455/41.3

(57) ABSTRACT

Methods for indicating the state of charge of the battery of a portable object, comprising a step for contactless transmission from a portable object to a telephone of the state of charge of the battery of the portable object, and a step for indication, via a human-machine interface of the telephone, of the state of charge of the battery of the portable object.

### BACKGROUND

1. Technical Field

The present document relates to a method for indicating the state of charge of the battery of a portable object, particularly suited to indicating the state of charge of the battery powering a hearing aid, and a telephone equipped with a contactless or wireless communication device implementing such a method. It also relates to a system comprising such a contactless telephone and an object comprising a power supply battery to be charged.

2. Description of the Related Art

Many portable objects, such as a hearing aid or a Bluetooth ear piece for example, now operate autonomously using a power supply battery. It is naturally necessary to exchange or recharge this battery when it is drained to be able to continue using such a portable object.

A portable object may, for example, comprise a hearing aid, whose function is to assist in the hearing of its wearer, who has at least one defective ear. A hearing aid comprises, at the input, microphones for picking up its environment, a processing unit for, in particular, filtering and amplifying the useful signal, then a loudspeaker for transmitting this processed sound by making it audible to an individual whose ear is defective. This operation uses an electrical power supply, which is in particular demand since the user of the hearing aid wears it for extended periods in or on his ear and may have a long term need for its assistance. Thus, the battery of a hearing aid discharges very rapidly.

The document EP1727395 proposes a solution to address this particular constraint, by avoiding the costly replacement of non-rechargeable hearing aid batteries. For this, it proposes a charging casing allowing for the positioning of two power supply batteries, which are recharged contactlessly via an electromagnetic field. This solution however retains the drawback of having to remove and then replace the batteries of the hearing aid very regularly. Typically, the user will have to use a spare battery while the other battery or batteries are in the charger in the recharging phase, if he desires continued use of the hearing aid. These battery handling operations are not user-friendly, and risk causing deterioration to the hearing aid when opening its casing to exchange the battery. They also present the risk of battery loss because of the small battery size. Finally, they also risk inducing deterioration to the battery housing in case of bad positioning of the battery within this housing.

The document U.S. 2009/285426 presents another solution in which a hearing aid is equipped with an antenna used both for the transmission of data and of power. A specific charger is provided to contactlessly recharge the hearing aid, using an oscillating circuit corresponding to the resonant oscillating circuit within the hearing aid, linked to its battery so as to be able to recharge it. This solution avoids having to remove the battery from a hearing aid for it to be recharged but requires the hearing aid to be removed from the ear in order to place it on a placement of a charger when its battery is discharged. During this period, the hearing aid cannot be used. Furthermore, it is often necessary to have a particular charger, dedicated to the hearing aid.

The document WO2010/108492 describes a solution in which a hearing aid communicates with a portable telephone via a short-range contactless communication, in order to use the hearing aid as an accessory of the telephone, making it possible to add extra functionalities to a telephone. This additional use of a hearing aid presents the drawback of further increasing the demand on the battery of the hearing aid and further reducing its autonomy, thus aggravating the issue explained previously.

All the preceding solutions show that the management of the battery of a portable object such as a hearing aid is very important, yet, in all these solutions, the user does not know the precise state of charge of his battery at a given instant, which is highly detrimental to this good management.

### BRIEF SUMMARY

One embodiment is a solution for indicating the state of charge of the battery of a portable object, such as a hearing aid, which provides for a more user-friendly and enhanced use of such a portable object.

One embodiment of the present disclosure includes a method for indicating the state of charge of the battery of a portable object, comprising a step for contactless transmission from a portable object to a telephone of the state of charge of the battery of the portable object, and a step for indication, via a human-machine interface of the telephone, of the state of charge of the battery of the portable object.

The method for indicating the state of charge of the battery of a portable object may comprise a step for estimation of the state of charge of the battery of a portable object by a processing unit of the portable object.

The human-machine interface of the telephone may comprise the display of at least one message on a screen of the telephone or the emission of at least one sound message.

The method for indicating the state of charge of the battery of a portable object may comprise an additional step for the contactless exchange of all or some of the following data between the portable object and the telephone:

a. transmission, from the portable object to the telephone, of data representing the state of health of the battery, such as ageing or deterioration; and/or

b. transmission of data characteristic of the operation of the portable object to the telephone; and/or

c. transmission by the telephone of parameters for setting the operation of the portable object, such as updates for software.

The method for indicating the state of charge of the battery may comprise a preliminary step for selection, via a human-machine interface of the telephone, of the request for the state of charge of the battery of a portable object by a user and a step for initiation of the indication method following this selection.

The method for indicating the state of charge of the battery of a portable object may comprise a preliminary step for detection of the proximity of a portable object by a telephone and a step for automatic initiation of the indication method following this detection.

The method for indicating the state of charge of the battery may comprise the following steps:
emission of an electromagnetic field by the telephone;
resonance of a resonant circuit of the portable object enabling a data communication between the portable object and the telephone.

The emission of an electromagnetic field by the telephone may be at a frequency of between 10 and 15 Megahertz (MHz) and/or this emission of an electro-magnetic field by the telephone may be suitable for a contactless communication at a distance less than or equal to 10 centimeters.

The method for indicating the state of charge of the battery of a portable object may comprise a step for contactless charging of the battery of the portable object by the electromagnetic field created by the telephone.

The disclosure also relates to a telephone comprising a wireless emission/reception device for conducting a telephone call, comprising a contactless communication device and a computer which implements the method for indicating the state of charge of the battery of a portable object as defined previously.

The contactless communication device may comprise a resonant circuit comprising an antenna.

The antenna of the resonant circuit of the contactless communication device may occupy more than half of the surface area of the telephone. The antenna of the resonant circuit of the contactless communication device may be incorporated in a screen of the telephone.

The telephone may comprise a screen and a human-machine interface making it possible to display the state of charge of the battery of a portable object on this screen.

The telephone may include a placement on the telephone at the level of the antenna of the resonant circuit of the contactless communication device provided for the portable object.

The disclosure also relates to a system comprising a hearing aid and a telephone, characterized in that the telephone is as described previously and in that the hearing aid may comprise a resonant circuit matched to the resonant circuit of the contactless communication device of the telephone, so as to be able to communicate to the telephone the state of charge of its battery via a contactless communication with the telephone.

The disclosure also relates to a system comprising a telephone and at least two different portable objects, characterized in that the telephone is as described previously and in that each portable object comprises a resonant circuit matched to the resonant circuit of the contactless communication device of the telephone, so as to be able to communicate to the telephone the state of charge of its battery via a contactless communication with the telephone.

### BRIEF DESCRIPTION OF THE SEVERAL VIEWS OF THE DRAWINGS

Aspects of the present disclosure will be explained in detail in the following description of a particular embodiment, given as a nonlimiting example, in relation to the appended figures in which:

FIG. 1 schematically represents a system comprising a hearing aid and a mobile telephone according to one embodiment of the disclosure.

FIG. 2 schematically represents the hearing aid according to one embodiment of the disclosure.

FIG. 3 schematically represents the telephone according to one embodiment of the disclosure.

FIG. 4 schematically represents another view of the telephone according to one embodiment of the disclosure.

### DETAILED DESCRIPTION

One or more embodiments disclosed are directed to indicating the charge of the battery of a portable object by a mobile telephone. This solution may offer one or more of the following advantages:
it makes it possible to inform a user of the state of charge of the battery of a portable object which does not include a human-machine interface and may not provide this information independently;
it enables a user to obtain this indication of the state of charge of the battery of the portable object without entailing interrupting the normal operation of the portable object, which may be very useful in the case of a hearing aid for example;
it makes it possible to use certain components that already exist on the telephone for a novel application of indicating the state of charge of a battery of a portable object, accompanied by additional services, as will be detailed hereinbelow;
it allows for the automatic, semi-automatic or manual management of this indication;
in the case of a hearing aid, it makes it possible to at least partially implement the indication method during a telephone communication.

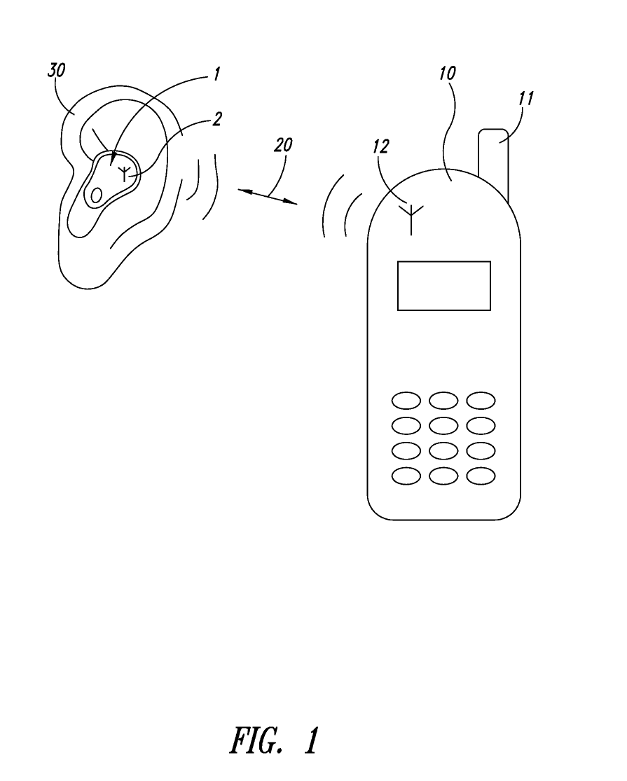

FIG. 1 represents a system according to an embodiment comprising a hearing aid 1 positioned in an ear 30 and a mobile telephone 10 equipped with a device for contactless or wireless communication with the hearing aid 1.

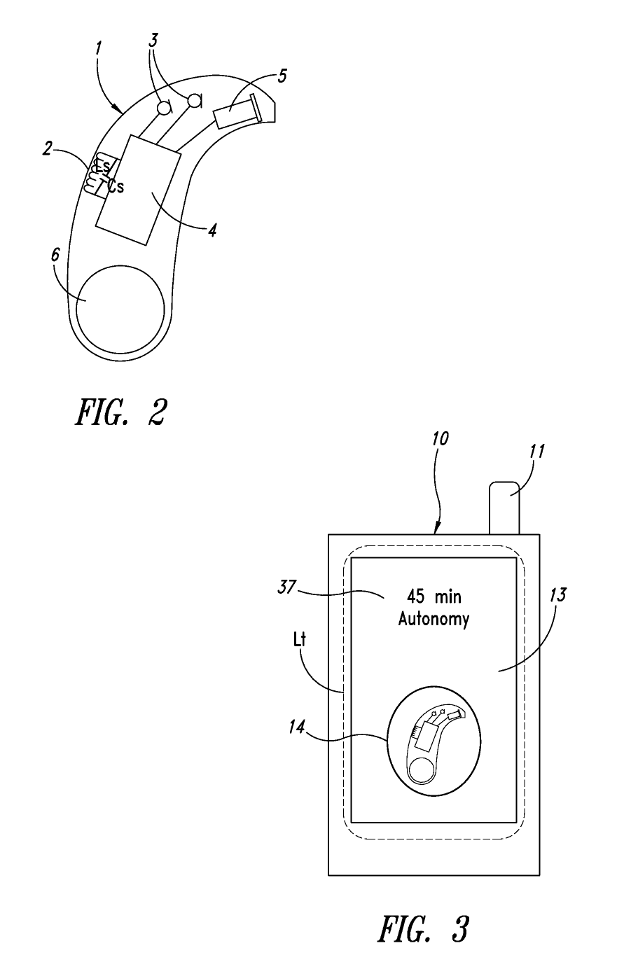

The hearing aid 1, more specifically represented in FIG. 2, is equipped with the usual components to fulfill a hearing aid function. Thus, it comprises at least one microphone 3, picking up the surrounding sound as input, a processing unit 4 comprising software and/or hardware means, such as a computer, for processing the incoming sound picked up by the microphone(s) 3, and transmitting a processed sound, notably a filtered and amplified sound, to the ear 30 of its wearer via a loudspeaker 5. Finally, the hearing aid 1 comprises a battery 6 for its power supply, notably for the needs of the processing unit 4. It also comprises a resonant circuit 2 suitable for contactless communication, as will be detailed hereinbelow. This resonant circuit 2 comprises an (inductance) antenna Ls and a capacitance Cs, thus forming an oscillating circuit that can start resonating at the chosen resonant frequency, according to the values of this inductance Ls and this capacitance Cs.

The mobile telephone 10 is equipped with the usual components for fulfilling the telephony function, allowing for a radio frequency telephone call according to the current standards by an antenna 11, such as the GSM, CDMA, EDGE, UMTS and other standards. In addition, the telephone is equipped with a contactless communication device comprising a resonant circuit 12 suitable for contactless data exchange with the hearing aid 1 via a contactless link 20, according to a battery charging method which will be detailed hereinbelow and at least partially implemented by a computing device of the telephone.

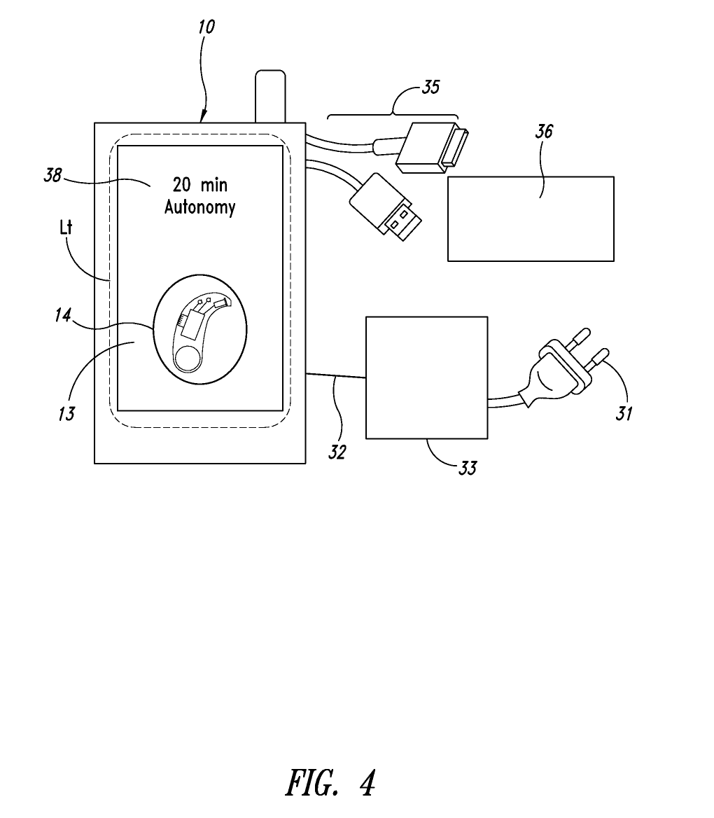

FIG. 3 represents a mobile telephone 10 according to one embodiment. Its contactless communication device mainly comprises an (inductance Lt) antenna Lt and a capacitance, not represented, to form a circuit that oscillates according to a resonant frequency that corresponds to, such as substantially equal to, or is a harmonic of, the resonant frequency of the resonant circuit 2 of the hearing aid 1, different from the frequency used for the telephone call via the antenna 11 of a particular geometrically suitable for long-range emissions and receptions at the frequency standardized for mobile telephone calls. On the other hand, the resonant circuit 12 of the telephone, and in particular its inductance antenna Lt, is designed for a short-range communication at a particular frequency distant from the telephone frequency. According to one embodiment, this antenna of the resonant circuit is incorporated around the screen 13 of the telephone and occupies a significant portion of its surface area. The antenna advantageously occupies at least half of the surface area of the telephone. As a variant, this antenna may be incorporated within the screen 13 of the telephone.

The resonant circuit 12 of the telephone 10 receives an electrical power supply so as to emit an electromagnetic field according to the predefined resonant frequency. This electrical power supply, as is schematically represented in FIG. 4, may originate from a battery of the telephone, shared by all the functions of the telephone or dedicated to the charger function, or from a link 32 from the telephone to an electrical mains supply 31 via its adapter 33, or from a link 35 with another distinct device 36 providing an electrical power supply to the telephone, such as a USB link with a computer, for example.

By this means, the resonant circuit of the telephone 10 can emit an electromagnetic field via its resonant circuit of the contactless communication device. The resonant circuit 2 of the hearing aid is matched to that of the telephone 10. Such an electromagnetic field created by a telephone 10 induces an electric current within the antenna Ls of the hearing aid 1, which is exploited for implementing data transmission from the telephone to the hearing aid 1. Thus, when the latter is positioned in the electromagnetic field of the telephone, it starts resonating and makes it possible to transmit data from the telephone, according to a so-called “contactless” remote power feed, unlike the links which require a physical electrical contact via an electrical connector. In return, the hearing aid 1 is also able to transmit data to the telephone 10 according to the same principle in reverse.

According to this embodiment, the resonant circuits of the hearing aid and of the telephone have physical characteristics, notably their respective inductances and capacitances, so as to form oscillating circuits which resonate at the same resonant frequency, in a radiofrequency domain. According to the preferred embodiment, this radiofrequency corresponds to a communication according to the technology known as near-field communication (NFC). As a variant, it may comprise a short-distance contactless communication at a frequency of between 10 and 15 MHz, or with any inductive coupling, allowing for a contactless communication at a short distance, less than or equal to 10 centimeters.

The operation of this system will now be explained, using a method for indicating the state of charge of the battery of the hearing aid according to one embodiment.

When a user wants to know the state of charge of the battery of his hearing aid, he communicates this request for information via a human-machine interface of his telephone. This human-machine interface may be implemented using written messages on the screen of the telephone or using sound messages, by exploiting the voice synthesis device of the telephone. Then, he brings the hearing aid and the telephone close together to allow the contactless communication between the two appliances according to the principle explained previously. The two appliances are then mutually detected, based on a proximity sensor, such as an infrared sensor or a “touch sensing” type sensor for example. The hearing aid 1, whose processing unit 4 implements a method for estimating the state of charge of the battery 6, transmits this value to the telephone via this contactless link 20. Finally, the telephone transmits this value to the user, via its human-machine interface.

It is worth noting that the contactless link 20 between the telephone 10 and the hearing aid 1 allows not only for a contactless transmission of data in both directions between the hearing aid 1 and the telephone 10, as has been described previously, but also for the transfer of power between the two appliances, which can, for example, be exploited for the recharging of the battery of the hearing aid. The transfer of data enables the hearing aid to transmit the information concerning the state of charge of its battery 6, as has been seen, but can obviously be exploited for the transfer of additional information concerning the state of health of its battery 6, that is to say, including information on its ageing and/or on any physical degradation, and data representing more generally the operation of the hearing aid 1. In return, the telephone 10 can transmit data to the hearing aid, for example parameters for setting its operation, updates for its sound processing software, and so on.

These data exchanged between the hearing aid 1 and the telephone 10 may be displayed on the screen 13 of the telephone, by a message 37, 38 as represented in FIGS. 3 and 4 for example. This screen 13 of the telephone 10 thus makes it possible to implement a human-machine interface between a user and the system, as explained previously, enabling this user to select requests from a number of available services, including the indication of this message 37 on the state of remaining charge of his hearing aid. A message conveying information to a user on the screen of the telephone may comprise simple logos. As a variant, the human-machine interface of the telephone may use the voice synthesis functionality of the telephone and transmit sound messages to its user, for example to transmit data to him from the hearing aid. Thus, the user can simply hear the state of charge of the battery of his hearing aid through the earpiece of his telephone.

It is worth noting that this contactless data communication between the telephone and the hearing aid may be conducted partially during a telephone communication, since, in this phase, the telephone is naturally in proximity to the hearing aid, so as to allow the contactless communication and, for example, the transmission of the state of charge of the battery of the hearing aid to the telephone, during the telephone communication.

Naturally, the method for contactless communication between the two appliances can be implemented outside of a telephone communication, and with the hearing aid removed from the ear of its wearer. To implement such a contactless communication, a hearing aid wearer can take out his hearing aid, position it in a placement 14 provided on his telephone, as is represented in FIGS. 3 and 4, roughly at the center of the antenna of its resonant circuit. Then, he manually activates the communication with the hearing aid via a dedicated human-machine interface, as explained previously. As a variant, this communication may be triggered automatically when the hearing aid is placed on a screen of the telephone, which the latter detects. Thus, in such a case, the hearing aid can directly and automatically transmit the state of charge of its battery to the telephone. The latter can either automatically transmit this indication to the user, or transmit to him in the case of a state of charge below a certain threshold, representing a situation requiring an imminent charge or an imminent change of battery, or transmit to him only when requested by the user.

According to one embodiment, a step for authorizing the contactless communication between the two appliances may be implemented, to avoid unlimited communications between all the telephones and all the portable objects, in the interests of safety. For this, the telephone may have, in a memory, identifiers of portable objects with which it is authorized to communicate. The portable object therefore transfers its identifier to the telephone, via the contactless link, which either recognizes it or does not. If the authentication is positive, then the communication between the portable object and the telephone is possible. Otherwise, the process is interrupted. As a variant, or in addition, each portable object may also reciprocally identify the telephone in proximity and determine whether it is authorized or not to implement the contactless communication.

The telephone 10 equipped in this way with a contactless communication device is suitable for indicating the remaining charge of the battery of many portable objects, and is not exclusively for a hearing aid. Since the telephone is an object that is very widely used and very often kept close by or even about his person by a user, the evolution of the telephone to universal battery charge indicator immediately appears to be a very useful solution. It will be accessible most of the time if need be. In particular, the telephone can thus communicate the state of charge of the battery of accessories such as a Bluetooth earpiece, a computer mouse, a GPS, a personal digital assistant (PDA), and so on. Thus, the solution retained also relates to a system comprising a telephone equipped with a contactless communication device and at least two distinct portable objects, of different kinds, that is to say fulfilling different functionalities, which are suited to a communication of the state of charge of their battery by this same telephone according to the principle explained previously. Such a telephone thus fulfils the multi-purpose or universal indicator function.

Naturally, this function for indicating the state of charge of a battery, added to a telephone, which may be a telephone with several functions, often called “smart phone”, is compatible with numerous other functions already present on a telephone, such as the PDA, camera, video camera, contact list and other such functions. Thus, this function for indicating the state of charge of a battery can be added to any mobile appliance, such as a personal digital assistant or a tablet, and in particular to any telephone. The latter can therefore fully manage all of the method for communicating with a portable object, using a dedicated human-machine interface. As a variant, all or part of this management may be transferred to the portable object, which also has software and/or hardware, such as a computer, enabling it to share this management and notably handle a local control of the charging method relating to its battery. For example, it may have a human-machine interface enabling its user to select part of the desired operations on the portable object, and not on the telephone, such as the request for the state of charge of the battery.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for indicating a state of charge of a battery of a portable object, the method comprising:
contactlessly receiving, from a portable object to a telephone, a communication indicative of the state of charge of the battery of the portable object; and
indicating the state of charge of the battery of the portable object via a user interface of the telephone.

2. The method according to claim 1, further comprising determining the state of charge of the battery of the portable object.

3. The method according to claim 1, wherein indicating the state of charge of the battery of the portable object via the user interface of the telephone comprises at least one of displaying a visual message and emitting a sound message.

4. The method according to claim 1, further comprising at least one of the following:
transmitting, from the portable object to the telephone, data representing the state of health of the battery;
transmitting, from the portable object to the telephone, data corresponding to an operation of the portable object; and
transmitting, from the telephone to the portable object, parameters for setting an operation of the portable object.

5. The method according to claim 1, further comprising:
selecting, via the user interface of the telephone, a request for the state of charge of the battery of a portable object

6. The method according to claim 1, further comprising:
determining whether the portable object is within a proximity of the telephone, wherein the wirelessly receiving includes automatically receiving the communication in response to determining that the portable object is within the proximity of the telephone.

7. The method according to claim 1, further comprising:
emitting an electromagnetic field from the telephone; and
resonating a resonant circuit of the portable object to enable data communication between the portable object and the telephone.

8. The method according to claim 7, wherein the electromagnetic field emitted from the telephone is at a frequency of between approximately 10 MHz and approximately 15 MHz.

9. The method according to claim 7, wherein the electromagnetic field emitted from the telephone is suitable for contactless communication at a distance less than or equal to 10 centimeters.

10. The method according to claim 7, further comprising contactlessly charging the battery of the portable object by the electromagnetic field emitted from the telephone.

11. A telephone comprising:
a wireless transceiver device configured to receive and transmit signals during a telephone call;
a communication device configured to contactlessly receive a communication indicative of a state of charge of a battery of a portable object; and
a user interface configured to indicate the state of charge of the battery of the portable object.

12. The telephone according to claim 11 wherein the communication device comprises a resonant circuit having an antenna.

13. The telephone according to claim 12 wherein the antenna of the resonant circuit occupies more than half of the surface area of the telephone.

14. The telephone according to claim 13 wherein the antenna of the resonant circuit is incorporated in a screen of the telephone.

15. The telephone according to claim 11, wherein the user interface includes at least one of a screen configured to display a visual message indicative of the state of charge of the battery and a speaker configured to transmit a sound message indicative of the state of the battery.

16. The telephone according to claim 11, further comprising a recess in the telephone configured to receive the portable object, the contactless communication device being configured to receive the communication indicative of the state of charge of the battery for the portable object in response to the portable object being placed into the recess.

17. The telephone according to claim 11, further comprising a computing device configured to send a request for a contactless transmission of the communication indicative of the state of charge of the battery of the portable object, and in response to the user interface receiving a request for the state of charge, the computing device requesting for the contactless transmission of the communication.

18. The telephone according to claim 11, further comprising a proximity sensor configured to sense whether the portable object is within a distance of the telephone, and cause the telephone to enable contactless communication between the portable object and the telephone.

19. A system comprising:
a portable object including a resonant circuit configured to resonate at first frequency; and
a telephone including a communication device configured to contactlessly receive a communication indicative of a state of charge of a battery of the portable object, the telephone further including a user interface configured to indicate the state of charge of the battery of the portable object.

20. The system of claim 19, wherein the communication device includes a resonant circuit configured to resonate at a second frequency, the second frequency corresponding to the first frequency.

21. The system of claim 19, wherein the user interface includes at least one of a screen and a speaker, the screen configured to display a visual message indicative of the state of charge of the battery of the portable object and the speaker configured to provide a sound message indicative of the state of charge of the battery of the portable object.

22. The system of claim 19, wherein the portable object is a hearing aid.

23. The system of claim 19, wherein the portable object is a first portable object, the system further comprising a second portable object including a resonant circuit configured to resonate at the first frequency.

24. The system of claim 19, wherein the telephone further includes a proximity sensor configured to sense whether the portable object is within a distance from the proximity sensor and cause the telephone to enable contactless communication between the portable object and the telephone.

25. The system of claim 19, further comprising a computing device configured to request the contactless transmission of the communication indicative of the state of charge of the battery of the portable object in response to input data received from the user interface.
